(19) United States
(12) Patent Application Publication
(10) Pub. No.: US 2011/0215123 A1
(43) Pub. Date: Sep. 8, 2011

(54) Nitrous Oxide Bottle Carrier

(76) Inventors: Robert James Garcia, JR., Aurora, CO (US); William Eckhardt, Centennial, CO (US)

(21) Appl. No.: 12/719,452

(22) Filed: Mar. 8, 2010

(51) Int. Cl. B60R 11/00

(52) U.S. Cl. 224/567

(57) ABSTRACT

A single-unit mount is provided for attaching a nitrous oxide bottle to a vehicle. The mount includes a bivalve clamp assembly mounted on legs to hold the bottle at an angle of declination approximating 23.5°.

### BACKGROUND

High performance automotive engines, such as those employed in race cars and the like, may be fitted with systems for dispensing nitrous oxide. These systems may be purchased on commercial order, for example, from DynoTune of Hudson, Massachusetts. The kits contain clamps for holding the nitrous oxide bottle, together with gauges, hoses and port adapters for fitting the kits to an engine. The use of nitrous oxide provides an increase in engine output.

A problem arises when mounting the nitrous oxide bottles on a vehicle. Although the bottles are frequently changed, the mounting systems are cumbersome to use. Typically, a pair of brackets are required, and each bracket must be fastened to the bottle in a fitting arrangement that resembles a large radiator hose clamp. Thus, changing the bottle requires an untoward amount of time.

### SUMMARY

The presently disclosed instrumentalities overcome the problems outlined above and advance the art by providing a nitrous oxide bottle mount that facilitates rapid changing of the bottle while securely retaining the bottle in the intended environment of use.

In one embodiment, a mount for retaining a nitrous oxide bottle on a vehicle includes a bivalve clamp assembly made of a bottom arcuate member presenting a terminal end, a top arcuate member presenting a first end, and a hinge pivotally coupling the bottom arcuate member with the top arcuate member. The bivalve clamp assembly is constructed and arranged such that the first end of the top arcuate member is movable on an arc extending from a closed position proximate the terminal end of the bottom arcuate member to an open position removed from the terminal end. A latch mechanism bridges the first end and the terminal end when the mount is in the closed position for selective locking of the bivalve clamp assembly. The bivalve clamp assembly is secured to an automobile to present a nitrous oxide bottle at an angle of declination relative to horizontal ranging from about 22° to 25°. The manner of securing the bivalve clamp assembly may be to provide legs, or a base pedestal.

The mount forms an essentially rigid assembly that in a closed position does not deform under the weight of a nitrous oxide bottle. Thus, in one aspect, the bottle may be retained by a single clamp that is easily retained by the compressive forces imparted by a spring-latch mechanism.

### BRIEF DESCRIPTION OF THE DRAWINGS

FIG. 1 is a top plan view of a mount for attaching a nitrous oxide bottle to a vehicle;

FIG. 2 is a front elevation view of the mount in a closed position;

FIG. 3 is a front elevation view of the mount in an open position;

FIG. 4 is a side elevation view showing a nitrous oxide bottle in the mount; and

FIG. 5 is a side elevation view of an alternative embodiment that incorporates a heating element.

### DETAILED DESCRIPTION

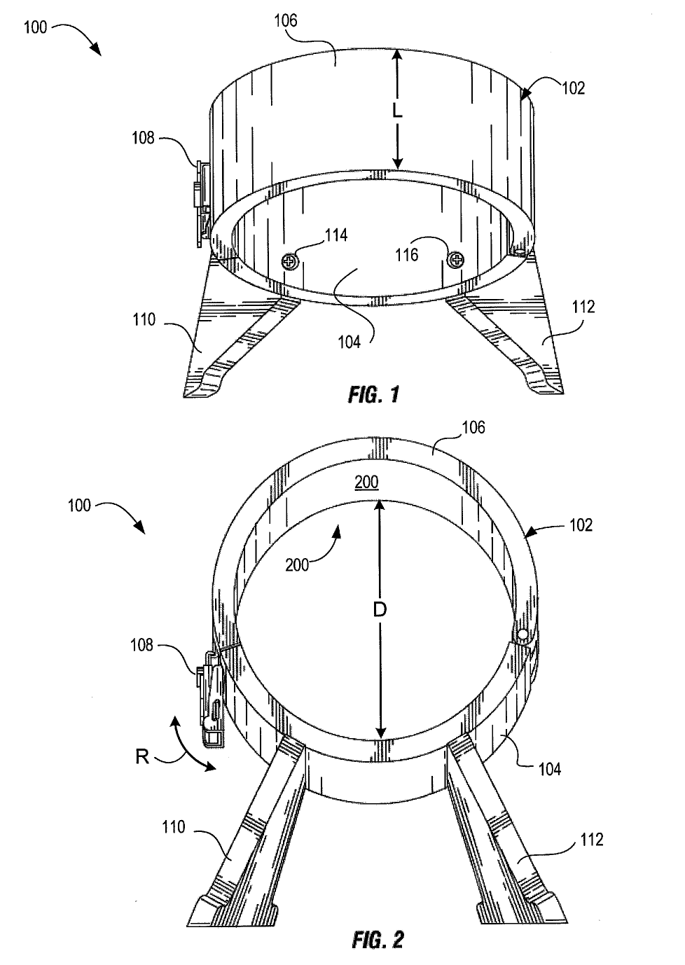

FIG. 1 is a plan view of a mount 100 that may be used to secure a nitrous oxide bottle to an automobile. The mount 100 includes a bivalve clamp assembly 102 formed of a bottom arcuate member 104, a top arcuate member 106, and a latch mechanism 108. A pair of legs 110, 112 are attached to the bottom arcuate member by connectors, such as bolts 114, 116. The legs 110, 112 may be replaced by other mounting structure, such as a unitary pedestal (not shown) or complementary mounting structure built into a vehicle. The top arcuate member and the bottom arcuate member preferably form a rigid body that is essentially free of deformation strain under the weight of a nitrous oxide bottle. This is especially facilitated by the length L being sufficiently great to form a rigid seal against the nitrous oxide bottle (not shown), such as a distance of ten centimeters or greater.

FIG. 2 is a front elevation view of the mount 100, which is constructed with a diameter D of a predetermined dimension to match the diameter of a nitrous oxide bottle (not shown). Pivoting of the latch along arc R selectively locks and unlocks the bivalve clamp assembly 102. As shown in FIG. 2, the bivalve clamp assembly 102 is in a closed position, such that downward rotation of the latch 108 places the latch mechanism 108 in compression to seal the top arcuate member 106 against a nitrous oxide bottle (not shown) that may be placed in the opening 200. Face 202 compressively lodges against the nitrous oxide bottle in this closed position.

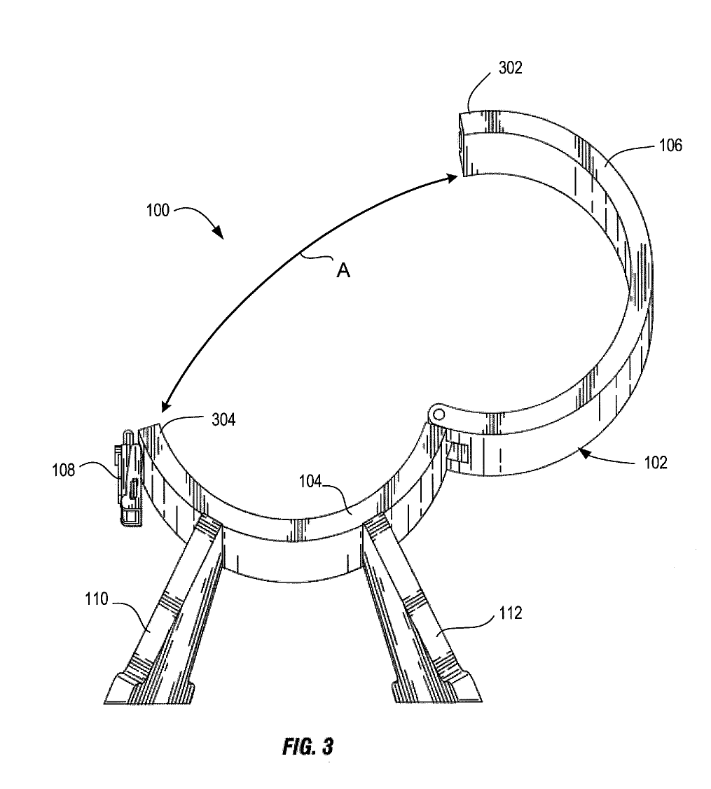

As shown in FIG. 3, a hinge 300 pivotally couples the top arcuate member 106 with the bottom arcuate member 104. This arrangement permits a first end 302 of the top arcuate member to travel along an arc A terminating in a closed position (see also FIG. 2) proximate a terminal end 304 of the bottom arcuate member 104. As shown in FIG. 3, the bivalve claim assembly 102 is in an open position with the first end 302 removed from the terminal end 304.

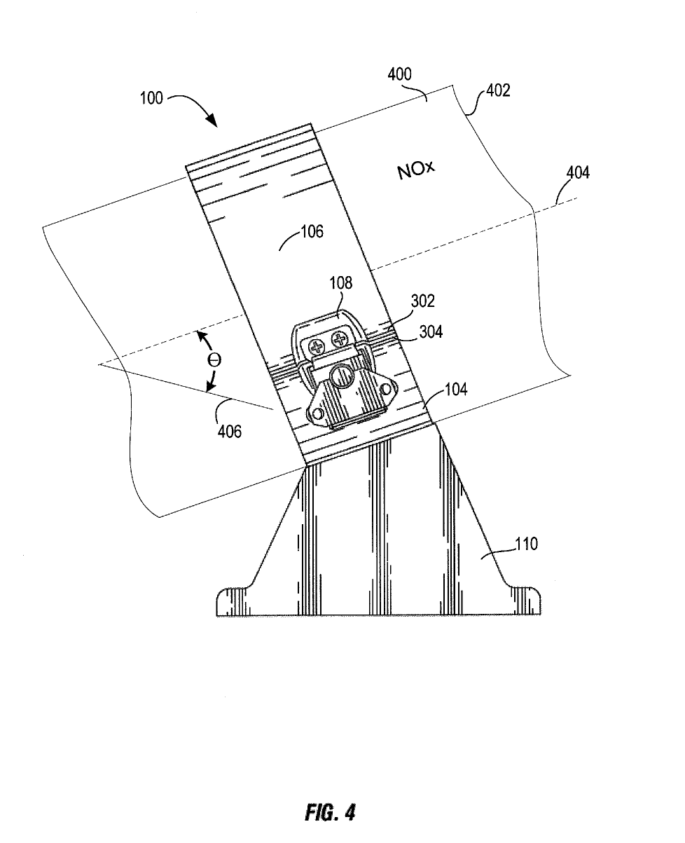

FIG. 4 is a side elevation view of the mount 100 retaining a nitrous oxide bottle 400. The nitrous oxide bottle 400 has an upper end where resides a gas regulator assembly (not shown). As is the convention in the art, the nitrous oxide bottle 400 presents an elongate axis of symmetry 404. The legs 110, 112 (or another type of mount) retain the bivalve clamp assembly at an angle of declination θ, which exists between the elongate axis of symmetry 404 and horizontal 406. The angle of declination θ is provided to facilitate the selective discharge of nitrous oxide from bottle 400 in the form of a gas, as opposed to a liquid, since the contents of bottle 400 may be under some conditions of temperature and pressure of mixed quality gas and liquid. The angle θ is by custom in the art 23.5°; however, this may be suitably from 22° to 25° or even 20° to 27°.

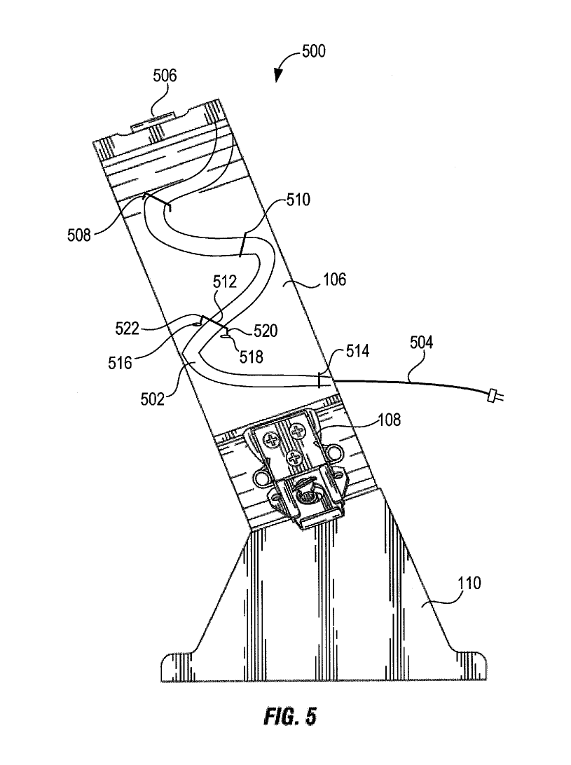

FIG. 5 shows an alternative mount 500. FIG. 5 retains like numbering of identical elements shown also in FIG. 4. The top arcuate member 106 is fitted with a resistive heating element 502 that receives electricity through power cord 504. Top arcuate member 106 has an optional logo 506. Staples 508, 510, 512, 514 retain the e resistive heating element 502 on top arcuate member 106. s shown by way of example in the case of staple 512, the top arcuate member 106 contains holes 516, 518 that are bored into the top arcuate member 106 at angles that splay the legs 520, 522 of staple 512 when legs 520, 522 are inserted into the holes 516, 518. The resistive heating element is used in some environments, such as winter driving or snowmobiling applications, to prevent clogging of the assembly that discharges nitrous oxide to the engine. The resistive heating element is alternatively secured to; the top arcuate member using a high temperature adhesive, such as an epoxy resin, or other suitable manner of attachment.

Those skilled in the art will appreciate that the foregoing discussion describes the invention; by way of example, and not by limitation. Insubstantial changes may be made to what has been shown and described without departing from the spirit of the invention. Accordingly, the inventor hereby states his intention to rely upon the Doctrine of Equivalents to protect the full scope of what is claimed.

What is claimed is:

1. A mount for retaining a nitrous oxide bottle on a vehicle, comprising:
a bivalve clamp assembly including
a bottom arcuate member presenting a terminal end,
a top arcuate member presenting a first end, and
a hinge pivotally coupling the bottom arcuate member with the top arcuate member such that a first end of the top arcuate member is movable on an arc extending from a closed position proximate the terminal end of the bottom arcuate member to an open position removed from the terminal end;
a latch mechanism bridging the first end and the terminal end when the mount is in the closed position for selective locking of the bivalve clamp assembly, means for securing the bivalve clamp assembly to an automobile to present a nitrous oxide bottle at an angle of declination relative to horizontal ranging from about 22° to 25°.

2. The mount of claim 1, wherein the top arcuate member and the bottom arcuate member for a rigid body that is essentially free of deformation strain under the weight of a nitrous oxide bottle.

3. The mount of claim 1, wherein the top arcuate member and the bottom arcuate member have a length of at least ten centimeters along the axis of symmetry.

4. The mount of claim 1, wherein the latch is constructed and arranged to form a compressive lock.

5. The mount of claim 1, further including a nitrous oxide bottle resident in the bivalve clamp assembly.

6. A method of mounting a nitrous oxide bottle in a vehicle, comprising:
placing the mount of claim 1 in a vehicle;
moving the top arcuate member to an open position;
placing a nitrous oxide bottle in the bivalve clamp assembly to reside between the top arcuate member and the bottom arcuate member;
moving the top arcuate member to the closed position; and
closing the latch mechanism to securely retain the nitrous oxide bottle.
